(19) United States
(12) Patent Application Publication
(10) Pub. No.: US 2026/0189166 A1
(43) Pub. Date: Jul. 2, 2026

(54) MOTOR DRIVE CONTROL DEVICE, MOTOR UNIT, AND MOTOR DRIVE CONTROL METHOD

(71) Applicant: MINEBEA MITSUMI Inc., Kitasaku-gun, Nagano (JP)

(72) Inventors: Masato AOKI, Kitasaku-gun, Nagano (JP); Hiroyuki KAIDU, Kitasaku-gun, Nagano (JP); Syu HAYASHI, Kitasaku-gun, Nagano (JP); Takahiro ASAMI, Kitasaku-gun, Nagano (JP)

(21) Appl. No.: 18/868,373

(22) PCT Filed: May 23, 2023
(86) PCT No.: PCT/JP2023/019066

§ 371 Date: Nov. 22, 2024

(30) Foreign Application Priority Data
May 25, 2022 (JP) 2022-085558

(51) Int. Cl. H02P 21/22; H02P 21/06; H02P 21/14

(52) U.S. Cl. CPC H02P 21/22; H02P 21/06; H02P 21/14; H02P 2205/01; H02P 2209/09

(57) ABSTRACT

To improve the drive efficiency of a motor. A motor drive control device configured to: determining a zero-crossing target point of a coil current of a U phase of the motor, based on a position detection signal synchronized with an induced voltage of a coil of the U phase of the motor and corresponding to a rotation position of a rotor of the motor; estimating, for each cycle of the PWM signal, a zero-crossing point of the coil current of the U phase based on interchanging of an order of a timing of a drive voltage of the coil of the U phase reaching a high level and a timing of a switch signal for turning on/off a high-side switch corresponding to the U phase reaching a high level; determining necessity of phase adjustment of the coil current based on a phase difference between the target point determined and the zero-crossing point estimated; and generating the drive control signal, based on a determination result obtained.

### TECHNICAL FIELD

The present invention relates to a motor drive control device, a motor unit, and a motor drive control method.

### BACKGROUND ART

In general, in a case of performing sinusoidal driving of a motor including a multi-phase coil, a technique of driving the motor with high efficiency by matching the phase of the induced voltage of the coil with the phase of the coil current (phase current) for each phase of the motor is known.

However, a shift may occur between the phase of the induced voltage and the phase of the coil current (phase current) due to the rotational speed of the motor, the load of the motor, and variation in the characteristics of the motor due to temperature, and the drive efficiency of the motor may be reduced.

As a technique for solving such a problem, Patent Document 1 discloses a method of adjusting a phase of a drive voltage of a coil with respect to a phase of a coil current of a motor. Specifically, the motor drive control device disclosed in Patent Document 1 provides a detection interval for detecting an induced voltage generated in a coil of a predetermined phase of the motor before and after a point (voltage zero crossing point). At the point, the induced voltage becomes zero by stopping the drive voltage of the coil. In addition, the motor drive control device detects the phase of the induced voltage of the coil by comparing the magnitude of the terminal voltage of the coil to the magnitude of the threshold voltage in the detection interval, and adjusts the phase of the drive voltage.

### CITATION LIST

### Patent Literature

Patent Document 1: JP 2015-23734 A

### SUMMARY OF INVENTION

### Technical Problem

However, in the technique disclosed in Patent Document 1, driving of the coil needs to be stopped in the detection period. Therefore, if the length of the period (detection period) for stopping driving of the coil is not appropriately set, the drive waveform of the motor may be disturbed, and rotation of the motor may be destabilized.

Therefore, the inventors of the present application believe there is a need for a new motor drive control technique for improving the drive efficiency of a motor.

The present invention is to solve the problems described above, and an object of the present invention is to improve the drive efficiency of a motor.

### Solution to Problem

A motor drive control device according to a representative embodiment of the present invention includes: a control circuit configured to generate a drive control signal being a PWM signal for driving a motor including at least a coil of one phase; and a driving circuit including a high-side switch and a low-side switch provided corresponding to a coil of each phase of the motor and connected in series with each other, the driving circuit being configured to switch an energization direction of a coil of a corresponding phase by alternately turning on/off the high-side switch and the low-side switch in accordance with the drive control signal. The control circuit includes: a target point determination unit configured to determine a zero-crossing target point of a coil current of a predetermined phase of the motor, based on a position detection signal synchronized with an induced voltage of a coil of the predetermined phase and corresponding to a rotation position of a rotor of the motor; a current zero-crossing point estimation unit configured to estimate, for each cycle of the PWM signal, a zero-crossing point of the coil current of the predetermined phase based on interchanging of an order of a timing of a drive voltage of the coil of the predetermined phase reaching a high level and a timing of a switch signal for turning on/off the high-side switch corresponding to the predetermined phase reaching a high level; a phase adjustment determination unit configured to determine necessity of phase adjustment of the coil current, based on a phase difference between the target point determined by the target point determination unit and the zero-crossing point estimated by the current zero-crossing point estimation unit; and a drive control signal generation unit configured to generate the drive control signal, based on a determination result obtained by the phase adjustment determination unit.

### Advantageous Effects of Invention

According to an aspect of the present invention, it is possible to improve the drive efficiency of a motor.

### BRIEF DESCRIPTION OF DRAWINGS

FIG. 1 is a diagram illustrating a configuration of a motor unit 100 including a motor drive control device 1 according to a first embodiment.

FIG. 2 is a diagram for describing a phase adjustment function of the motor drive control device 1 according to the first embodiment.

FIG. 3A is a diagram for describing a state of a U-phase high-side switch QuH and a U-phase low-side switch QuL being turned off in a state of a U-phase coil current Iu with positive (+) polarity flowing through a U-phase coil Lu.

FIG. 3B is a diagram for describing a state of a U-phase high-side switch QuH and a U-phase low-side switch QuL being turned off in a state of a U-phase coil current Iu with negative (−) polarity flowing through the U-phase coil Lu.

FIG. 4 is a diagram illustrating a state of the U-phase coil Lu being driven.

FIG. 5A is a diagram illustrating the region indicated with the reference symbol A in FIG. 4 in an enlarged manner.

FIG. 5B is a diagram illustrating the region indicated with the reference symbol B in FIG. 4 in an enlarged manner.

FIG. 6 is a diagram illustrating a configuration example of a current zero-crossing point estimation unit 14 in the first embodiment.

FIG. 7 is a flowchart illustrating a procedure of a motor drive control process of the motor drive control device 1 according to the first embodiment.

FIG. 8 is a flowchart illustrating a procedure of an estimation process (step S4) of the zero-crossing point Q of the U-phase coil current Iu in FIG. 7.

FIG. 9 is a flowchart illustrating a procedure of an adjustment process (step S5) of the energization timing of a motor 5 in FIG. 7.

FIG. 10 is a diagram illustrating a configuration example of a current zero-crossing point estimation unit 14A in a second embodiment.

FIG. 11 is a diagram for describing a polarity determination of the current zero-crossing point estimation unit 14A of the second embodiment.

FIG. 12 is a flowchart illustrating a procedure of an estimation process (step S4) of the zero-crossing point Q of a U-phase coil current Iu in the second embodiment.

### DESCRIPTION OF EMBODIMENTS

### 1. Overview of Embodiments

First, an overview of typical embodiments of the invention disclosed in the present application will be described. In the following description, by way of example, reference symbols on the drawings corresponding to the components of the invention are indicated in parentheses.

[1] A motor drive control device (1, 1A) according to a representative embodiment of the present invention includes: a control circuit configured to generate a drive control signal (Sd, Suu, Sul, Svu, Svl, Swu, Swl) being a PWM signal for driving a motor (5) including at least a coil of one phase; and a driving circuit (3) including a high-side switch (QuH, QvH, QwH) and a low-side switch (QuL, QvL, QwL) provided corresponding to a coil (Lu, Lv and Lw) of each phase of the motor and connected in series with each other, the driving circuit (3) being configured to switch an energization direction of a coil of a corresponding phase by alternately turning on/off the high-side switch and the low-side switch in accordance with the drive control signal, wherein the control circuit includes a target point determination unit (12) configured to determine a zero-crossing target point (Q) of a coil current of a predetermined phase (for example, U-phase) of the motor based on a position detection signal (Shu) synchronized with an induced voltage of a coil of the predetermined phase and corresponding to a rotation position of a rotor of the motor; a current zero-crossing point estimation unit (14, 14A) configured to estimate, for each cycle of the PWM signal, a zero-crossing point (P) of the coil current of the predetermined phase based on interchanging of an order of a timing (first timing) of a drive voltage (Vu) of the coil of the predetermined phase reaching a high level and a timing (second timing) of a switch signal (Suu) for turning on/off the high-side switch (QuH) corresponding to the predetermined phase reaching a high level; a phase adjustment determination unit (15) configured to determine necessity of phase adjustment of the coil current based on a phase difference (Δφ) between the target point determined by the target point determination unit and the zero-crossing point estimated by the current zero-crossing point estimation unit; and a drive control signal generation unit (16) configured to generate the drive control signal, based on a determination result obtained by the phase adjustment determination unit.

[2] In the motor drive control device according to [1], the current zero-crossing point estimation unit may include a rising edge detection unit configured to detect each of a rising edge of the drive voltage and a rising edge of the switch signal, and a timing comparison unit configured to determine the order by comparing detection timings of the rising edge of the drive voltage and the rising edge of the switch signal detected by the rising edge detection unit.

In the motor drive control device according to [2], the current zero-crossing point estimation unit may further include a current direction determination unit configured to determine the coil current of the predetermined phase to have positive polarity when the detection timing of the rising edge of the drive voltage is after the detection timing of the rising edge of the switch signal, and determine the coil current of the predetermined phase to have negative polarity when the detection timing of the rising edge of the drive voltage is before the detection timing of the rising edge of the switch signal.

[4] In the motor drive control device according to [3], the current zero-crossing point estimation unit may further include a zero-crossing point detection unit configured to estimate the zero-crossing point to be present in an off period of the drive voltage while the coil current of the predetermined phase changes from having positive polarity to having negative polarity or from having negative polarity to having positive polarity.

[5] In the motor drive control device according to [1], the current zero-crossing point estimation unit may include a comparator configured to determine the order by comparing a magnitude of the drive voltage and a magnitude of a voltage of the switch signal.

[6] In the motor drive control device according to [1], the comparator may output a pulse when the magnitude of the voltage of the switch signal is greater than the magnitude of the drive voltage, and the current zero-crossing point estimation unit may further include a current direction determination unit configured to determine the coil current of the predetermined phase to have positive polarity when an output of the pulse is detected within a certain period of time, and determine the coil current of the predetermined phase to have negative polarity when an output of the pulse is not detected within a certain period of time.

[7] In the motor drive control device according to [6], the current zero-crossing point estimation unit may further include a zero-crossing point detection unit configured to estimate the zero-crossing point to be present in an off period of the drive voltage while the coil current of the predetermined phase changes from having positive polarity to having negative polarity or from having negative polarity to having positive polarity.

[8] In the motor drive control device according to [7], the phase adjustment determination unit may calculate the phase difference between the target point and the zero-crossing point, and instructs the drive control signal generation unit to shift an output timing of the drive control signal by a time corresponding to the phase difference.

[9] A motor unit (100) according to a representative embodiment of the present invention includes the motor drive control device (1, 1A) according to any one of [1] to [8], and the motor (5).

[10] A motor drive control method according to a representative embodiment of the present invention is a method of a motor drive control device, the motor drive control device including: a control circuit configured to generate a drive control signal, the drive control signal being a PWM signal for driving a motor including a coil of at least one phase; and a driving circuit configured to switch an energization direction of a coil of a corresponding phase by alternately turning on/off a high-side switch and a low-side switch in accordance with the drive control signal, the high-side switch and the low-side switch being provided corresponding to the coil of each phase of the motor and connected in series with each other, wherein the method includes: a first step (S3) of determining, by the control circuit, a zero-crossing target point of a coil current of a predetermined phase of the motor based on a position detection signal synchronized with an induced voltage of the coil of the predetermined phase of the motor and corresponding to a rotation position of a rotor of the motor; a second step (S4) of estimating, by the control circuit, a zero-crossing point of the coil current of the predetermined phase based on interchanging of an order of a timing when a drive voltage of the coil of the predetermined phase becomes a high level and a timing when a switch signal for turning on/off the high-side switch corresponding to the predetermined phase becomes a high level for each cycle of the PWM signal; a third step (S52, S53) of determining, by the control circuit, necessity of phase adjustment of the coil current based on a phase difference between the target point determined by the first step and the zero-crossing point estimated by the second step; and a fourth step (S54 to S56) of generating, by the control circuit, the drive control signal based on a determination result obtained by the third step.

### 2. Specific Examples of Embodiments

Hereinafter, specific examples of embodiments of the present invention will be described with reference to the drawings. In the following description, the components common to the embodiments are denoted by the same reference signs, and repeated descriptions are omitted.

### First Embodiment

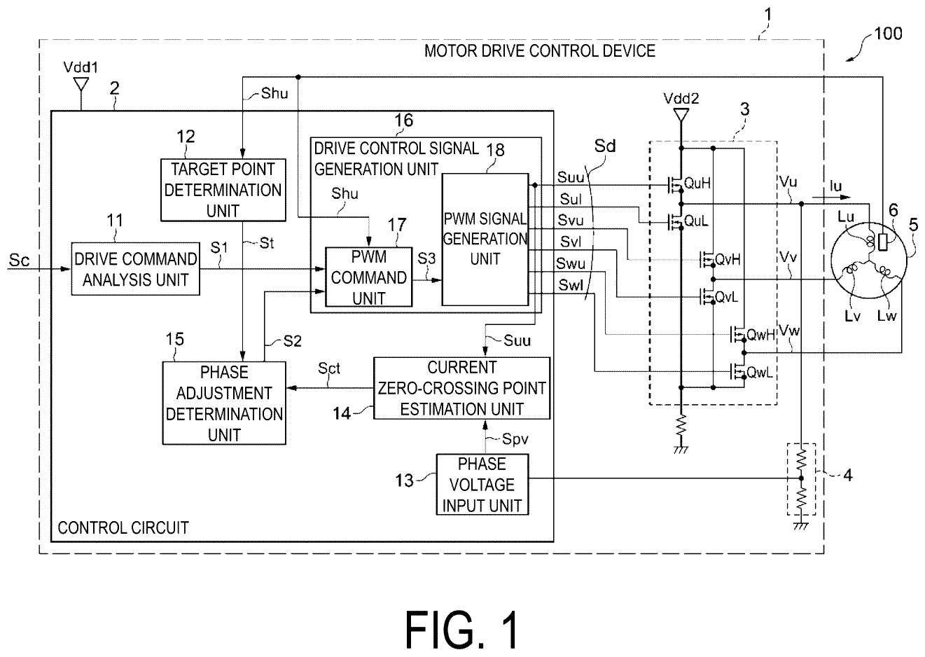

FIG. 1 is a configuration of a motor unit 100 including a motor drive control device 1 according to a first embodiment.

The motor unit 100 illustrated in FIG. 1 includes a motor 5, a position detection device 6, and the motor drive control device 1.

The motor 5 is a motor including at least one coil. For example, the motor 5 is a brushless DC motor including three-phase (U-phase, V-phase, and W phase) coils (windings) Lu, Lv and Lw.

The position detection device 6 is a device for generating a position detection signal Shu corresponding to the rotation of the rotor of the motor 5. The position detection device 6 is a Hall element, for example. The Hall element detects a magnetic pole of the rotor, and outputs a Hall signal whose voltage changes in accordance with the rotation of the rotor. The Hall signal is a pulse signal, and is input to the motor drive control device 1 as the position detection signal Shu, for example.

In the motor unit 100, one Hall element serving as the position detection device 6 is disposed at a position corresponding to any one of the coils Lu, Lv and Lw of U-phase, V-phase, and W phase of the motor 5. In this manner, the Hall signal output from the position detection device 6 is a signal synchronized with the induced voltage of any one of the coils Lu, Lv and Lw of U-phase, V-phase, and W phase of the motor 5.

In the first embodiment, one Hall element serving as the position detection device 6 is disposed at a position corresponding to a U-phase coil Lu, for example. In this manner, a position detection signal (Hall signal) Shu is a signal synchronized with the induced voltage of the U-phase coil Lu of the motor 5 and corresponding to the rotation position of the rotor of the motor 5.

As elaborated later, in the first embodiment, as a specific example, the position detection device 6 is disposed at a position. At the position, the rising edge of the position detection signal (Hall signal) Shu output from the position detection device 6 can be detected at a timing delayed by an electrical angle of 30 degrees from the zero-crossing point of the induced voltage of the U-phase coil Lu.

The motor drive control device 1 is a device for controlling the drive of the motor 5. The motor drive control device 1 performs the sinusoidal driving of the motor 5 by a one-sensor drive system based on the position detection signal Shu from one position detection device 6 (Hall element) provided at a position corresponding to the U-phase coil Lu, for example.

More specifically, the motor drive control device 1 includes a control circuit 2, a driving circuit 3, and a phase voltage detection circuit 4. The motor drive control device 1 receives supply of a DC voltage Vdd (not illustrated in the drawing) from an external DC power source (not illustrated in the drawing). The DC voltage Vdd is supplied to a power-source line (not illustrated in the drawing) in the motor drive control device 1 through a protection circuit or the like, and input to the control circuit 2 and the driving circuit 3 through the power-source line as power source voltages Vdd1 and Vdd2, for example.

The DC voltage Vdd is not directly supplied to the control circuit 2, but a voltage obtained by stepping down the DC voltage Vdd by a regulator circuit is supplied to the control circuit 2 as the power source voltage Vdd1, for example. For example, the power source voltage Vdd1 input to the control circuit 2 is set to 5 V, and the power source voltage Vdd2 input to the driving circuit 3 is set to 12 V or the like.

The driving circuit 3 is a circuit for driving the motor 5 on the basis of a drive control signal Sd output from the control circuit 2 described later. The drive control signal Sd is a signal for controlling the drive of the motor 5. For example, the drive control signal Sd is a PWM signal for sinusoidally driving the motor 5.

The driving circuit 3 rotates the motor 5 by switching the direction of the coil current by switching the connection destination of the coil of the motor 5 between the power source voltage Vdd2 and a ground potential GND on the basis of the drive control signal Sd. Specifically, the driving circuit 3 includes low-side switches QuL, QvL and QwL and high-side switches QuH, QvH and QwH provided corresponding to the coils Lu, Lu and Lw of each phase of the motor 5, and connected in series with each other. The driving circuit 3 switches the energization directions of the coils Lu, Lv and Lw by turning on/off the high-side switches QuH, QvH and QwH and the low-side switches QuL, QvL and QwL in accordance with PWM signals (an example of the switch signal) Suu, Sul, Svu, Svl, Swu and Swl serving as the drive control signal Sd.

The PWM signals Suu, Sul, Svu, Svl, Swu and Swl are input correspondingly to each of six switches, namely the high-side switches QuH, QvH and QwH and the low-side switches QuL, QvL and QwLm, so as to switch on/off the corresponding switch.

For example, the high-side switches QuH, QvH and QwH are P channel type MOSFETs (Metal-Oxide-Semiconductor Field Effect Transistors), and the low-side switches QuL, QvL and QwL are N channel type MOSFETs.

The high-side switches QuH, QvH and QwH and the low-side switches QuL, QvL and QwL may be power transistors of other types such as IGBT (Insulated Gate Bipolar Transistor), for example.

As illustrated in FIG. 1, the U-phase high-side switch QuH and low-side switch QuL are connected in series between the power source voltage Vdd2 and the ground potential GND, thus forming one switching leg (arm). The connection point of the high-side switch QuH and the low-side switch QuL is connected to one end of coil Lu. The on/off of the high-side switch QuH is switched by the PWM signal Suu. The on/off of the low-side switch QuL is switched by the PWM signal Sul.

The V-phase high-side switch QvH and low-side switch QvL are connected in series between the DC voltage Vdd and the ground potential GND, thus forming one switching leg. The connection point of the high-side switch QvH and the low-side switch QvL is connected to one end of a coil Lv. The on/off of the high-side switch QvH is switched by the PWM signal Svu. The on/off of the low-side switch QvL is switched by the PWM signal Svl.

The W-phase high-side switch QwH and low-side switch QwL are connected in series between the power source voltage Vdd2 and the ground potential GND, thus forming one switching leg. The connection point of the high-side switch QwH and the low-side switch QwL is connected to one end of a coil Lw. The on/off of the high-side switch QwH is switched by the PWM signal Swu. The on/off of the low-side switch QwL is switched by the PWM signal Swl.

A parasitic diode is formed in each transistor serving as the high-side switches QuH, QvH and QwH and the low-side switches QuL, QvL and QwL, and these diodes function as return diodes for returning the coil current to the power source voltage Vdd2 or the ground potential GND.

The driving circuit 3 may include a pre-drive circuit for driving a high-side switch and a low-side switch of each phase on the basis of the drive control signal Sd. In addition, as illustrated in FIG. 1, a sense resistor for detecting the current of the motor 5 may be connected at the ground potential GND side of the driving circuit 3.

The phase voltage detection circuit 4 is a circuit for detecting the drive voltage of the coil of the predetermined phase of the motor 5. In the first embodiment, the phase voltage detection circuit 4 detects a drive voltage Vu of the U-phase coil Lu and inputs the voltage to the control circuit 2, for example. The phase voltage detection circuit 4 is a resistive voltage divider circuit connected between the ground potential GND and one end of coil Lu. The U-phase high-side switch QuH and the U-phase low-side switch QuL are connected to the one end of coil Lu.

FIG. 1 illustrates an example of a configuration. In the illustrated configuration, the drive voltage Vu of the coil Lu is divided with a resistive voltage divider circuit serving as the phase voltage detection circuit 4 and input to the control circuit 2, but the drive voltage Vu of the coil Lu may be directly input to the control circuit 2 without providing the phase voltage detection circuit 4.

The control circuit 2 is a circuit for generally controlling the operation of the motor drive control device 1. In the first embodiment, the control circuit 2 is a program processing device with a configuration including a processor such as a CPU, various storage devices such as a RAM, a ROM, and a flash memory, a counter (timer), an A/D conversion circuit, a D/A conversion circuit, a clock generation circuit, and a peripheral circuit such as an input/output interface circuit connected with each other through a bus and a dedicated line, for example. For example, the control circuit 2 is a micro controller (MCU: Micro Controller Unit).

The control circuit 2 and the driving circuit 3 may be configured to be packaged as one semiconductor integrated circuit (IC), or may be separately packaged as individual integrated circuits mounted at the circuit board and electrically connected with each other on the circuit board.

The control circuit 2 has a basic function of performing energization control of the motor 5 by generating the drive control signal Sd and providing the signal to the driving circuit 3. Specifically, on the basis of a drive command signal Sc for instructing a target value related to the drive of the motor 5 input from the outside (for example, higher-level device), and the position detection signal Shu input from the position detection device 6, the control circuit 2 generates the drive control signal Sd so as to set the motor 5 to the driving state designated by the drive command signal Sc and provides the signal to the driving circuit 3.

In addition, in addition to the above-mentioned basic function, the control circuit 2 has a function (hereinafter referred to also as “phase adjustment function”) of adjusting the energization timing of the motor 5 so as to make the phase of the induced voltage of the coil of the predetermined phase of the motor 5 and the phase of the coil current coincide with each other for the purpose of improving the drive efficiency of the motor 5.

As illustrated in FIG. 1, the control circuit 2 includes, as functional units for achieving the above-described functions, a drive command analysis unit 11, a target point determination unit 12, a phase voltage input unit 13, a current zero-crossing point estimation unit 14, a phase adjustment determination unit 15, and a drive control signal generation unit 16, for example.

The above-described functional units of the control circuit 2 are implemented by program processing of the MCU serving as the control circuit 2. More specifically, the above-described functional units are implemented when the processor making up the MCU serving as the control circuit 2 performs various computations in accordance with the program stored in the memory to control various peripheral circuits making up the MCU.

The drive command analysis unit 11 receives the drive command signal Sc output from a higher-level device (not illustrated in the drawing), for example. The drive command signal Sc is a signal for instructing a target value related to the drive of the motor 5, and is a velocity command signal for instructing the target rotational speed of the motor 5, for example.

The drive command analysis unit 11 analyzes the target rotational speed designated by the drive command signal Sc. For example, when the drive command signal Sc is a PWM signal with a duty ratio corresponding to the target rotational speed, the drive command analysis unit 11 analyzes the duty ratio of the drive command signal Sc, and outputs the information on the rotational speed corresponding to the duty ratio as a target rotational speed S1.

The drive control signal generation unit 16 calculates an operation amount S3 of the motor 5 so as to make the rotational speed of the motor 5 coincide with the target rotational speed S1, and generates the drive control signal Sd on the basis of the calculated operation amount S3. The function of the drive control signal generation unit 16 related to the phase adjustment will be described later.

The drive control signal generation unit 16 includes a PWM command unit 17 and a PWM signal generation unit 18, for example. The PWM command unit 17 calculates the operation amount S3 of the motor 5 on the basis of the target rotational speed S1 output from the drive command analysis unit 11 and a determination result S2 of the phase adjustment determination unit 15 described later.

The operation amount S3 includes information for designating the driving amount of the motor 5 required for rotating the motor 5 at the target rotational speed S1. For example, when the motor 5 is PWM-driven as in the first embodiment, the operation amount S3 includes the value for designating the cycle (PWM cycle) of the PWM signal serving as the drive control signal Sd, the value for designating the on period of the PWM signal, and the value for designating the output timing of the PWM signal. The value for designating the output timing of the PWM signal will be described in detail later.

For example, the PWM command unit 17 calculates the value for designating the PWM cycle of the drive control signal Sd and the value for designating the on period of the PWM signal on the basis of the target rotational speed S1 output from the drive command analysis unit 11, and outputs the values as the operation amount S3.

When the motor drive control device 1 has a feedback-control function, the PWM command unit 17 may calculate the operation amount S3 of the motor 5 (PWM cycle and on period) by calculating the actual rotational speed of the motor 5 on the basis of the position detection signal Shu, and performing PID (Proportional-Integral-Differential) control computation so as to make the calculated actual rotational speed coincide with the target rotational speed S1, for example.

The PWM signal generation unit 18 generates the drive control signal Sd on the basis of the operation amount S3 calculated by the PWM command unit 17. More specifically, the PWM signal generation unit 18 generates six types of PWM signals (examples of the switch signals) Suu, Sul, Svu, Svl, Swu and Swl including the PWM cycle and on period designated by the operation amount S3, and outputs the signals as the drive control signals Sd. The PWM signal Suu is a signal for switching the on/off of the U-phase high-side switch QuH. The PWM signal Sul is a signal for switching the on/off of the U-phase low-side switch QuL. The PWM signal Svu is a signal for switching the on/off of the V-phase high-side switch QvH. The PWM signal Svl is a signal for switching the on/off of the V-phase low-side switch QvL. The PWM signal Swu is a signal for switching the on/off of the W-phase high-side switch QwH. The PWM signal Swl is a signal for switching the on/off of the W-phase low-side switch QwL.

In the first embodiment, a dead time period for preventing the high-side switch and the low-side switch making up the switch legs of U-phase, V-phase and W-phase from simultaneously turning on is provided. Specifically, the PWM signal generation unit 18 generates the drive control signal Sd (the above-mentioned six types PWM signal) so as to form the dead time period of simultaneously turning off the high-side switch and the low-side switch when the on/off state of the high-side switch and the low-side switch making up the switch legs of U-phase, V-phase and W-phase is switched.

The target point determination unit 12, the phase voltage input unit 13, the current zero-crossing point estimation unit 14, and the phase adjustment determination unit 15 are functional units for achieving the phase adjustment function of the motor 5 described above. Prior to elaboration of the functional units, an overview of the phase adjustment function according to the first embodiment is described below.

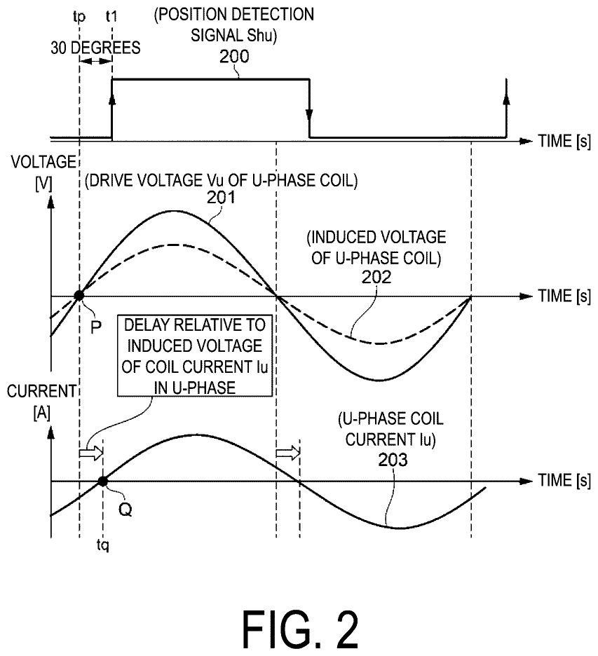

FIG. 2 is a diagram for describing a phase adjustment function of the motor drive control device 1 according to the first embodiment.

In FIG. 2, the upper part illustrates a waveform 200 of the position detection signal (Hall signal) Shu output from the position detection device 6, the middle part illustrates a waveform 201 of the drive voltage Vu of the U-phase coil Lu and a waveform 202 of the induced voltage of the U-phase coil Lu, and the lower part illustrates a waveform 203 of the U-phase coil current Iu.

As described above, in general, the phase of the induced voltage of the motor and the phase of the coil current may be shifted from each other due to the rotational speed of the motor, the load of the motor, variation in the characteristics of the motor of due to temperature and the like. For example, FIG. 2 illustrates when the phase of the U-phase coil current Iu is delayed with respect to the phase of the induced voltage of the U-phase coil Lu.

As illustrated in FIG. 2, when phase shift occurs between the U-phase coil current Iu and the induced voltage, the drive efficiency of the motor 5 is reduced. In view of this, the motor drive control device 1 according to the first embodiment detects a shift (phase difference) between the U-phase coil current Iu and the induced voltage, and adjusts the energization timing of the motor 5 so as to reduce the phase difference.

More specifically, first, the motor drive control device 1 detects the zero-crossing point of the induced voltage by using the position detection signal (Hall signal) Shu output from the position detection device 6 (Hall element) provided corresponding to the U-phase coil Lu as being synchronized with the induced voltage of the U-phase coil Lu, and sets the point to a zero-crossing target point P of the U-phase coil current Iu.

In the first embodiment, as illustrated in FIG. 2, the position detection device 6 is disposed in advance at a position. At the position, the position detection device 6 can perform detection at a timing of the rising edge of the position detection signal Shu being delayed by an electrical angle of 30 degrees from the zero-crossing point of the induced voltage of the U-phase coil Lu, for example. In this manner, the motor drive control device 1 can detect (estimate) the zero-crossing point of the induced voltage of the coil Lu by detecting the rising edge or falling edge of the position detection signal Shu.

The installation position of the position detection device 6 is not limited to the above-described example as long as the phase difference between the timing of the rising edge of the position detection signal Shu being detected and the zero-crossing point of the phase of the induced voltage of the U-phase coil Lu of the position is known.

The motor drive control device 1 detects the rising edge or falling edge of the position detection signal Shu, and estimates the zero-crossing point of the induced voltage from at least one of the detected edges. The motor drive control device 1 determines the estimated zero-crossing point of the induced voltage to be the zero-crossing target point P of the U-phase coil current Iu.

Next, the motor drive control device 1 compares the timing of the drive voltage (phase voltage) of the coil of a predetermined phase (in the first embodiment, U-phase) reaching a high level, and the timing of a PWM signal (an example of the switch signal) for turning on/off the high-side switch corresponding to the predetermined phase reaching a high level, and estimates the zero-crossing point Q of the coil current of the predetermined phase of the motor 5 on the basis of the comparison result. The estimation method for the zero-crossing point Q of the coil current will be described in detail later.

Then, the motor drive control device 1 adjusts the phase of the U-phase coil current Iu so as to make the estimated zero-crossing point Q of the U-phase coil current Iu coincide with the zero-crossing target point P of the U-phase coil current Iu (the zero-crossing point of the induced voltage). For example, as illustrated in FIG. 2, the phase of the U-phase coil current Iu is adjusted by adjusting the applying timing of the drive voltage Vu of the U-phase coil Lu (by performing advance angle control or delay angle control) so as to make the zero-crossing point Q of the U-phase coil current Iu coincide with target point P. In this manner, the motor drive control device 1 can improve the drive efficiency of the motor 5.

Each functional unit for implementing the above-described phase adjustment function is elaborated below.

The target point determination unit 12 determines the target point P of the zero-crossing of the coil current of the predetermined phase on the basis of the position detection signal Shu synchronized with the induced voltage of the coil of the predetermined phase of the motor 5 and corresponding to the rotation position of the rotor of the motor 5.

In the first embodiment, the target point determination unit 12 detects the rising edge or falling edge of the position detection signal Shu synchronized with the induced voltage of the U-phase coil Lu, and determines, on the basis of the detected edge, the zero-crossing point of the induced voltage of the U-phase coil Lu, i.e., the target point P of the zero-crossing of the U-phase coil current Iu. For example, in FIG. 2, when the target point determination unit 12 detects the rising edge of the position detection signal Shu at time t1, the target point determination unit 12 determines a time (timing) to as the target point P of the zero-crossing of the U-phase coil current Iu. The time to is ahead of the time t1 by an electrical angle of 30 degrees. Also when detecting the falling edge of the position detection signal Shu, the target point P of the zero-crossing of the U-phase coil current Iu is determined by the same method. The target point determination unit 12 outputs to the phase adjustment determination unit 15 the phase information of the determined target point P of the zero-crossing of the U-phase coil current Iu as a target point determination signal St.

The phase voltage input unit 13 acquires the value of the voltage of the predetermined phase of the motor 5. For example, the phase voltage input unit 13 acquires the drive voltage Vu of the U-phase coil Lu detected by the phase voltage detection circuit 4, converts this voltage into a digital value, and supplies this value to the current zero-crossing point estimation unit 14.

The current zero-crossing point estimation unit 14 is a functional unit for estimating the zero-crossing point Q of the coil current of the predetermined phase on the basis of interchanging of the order of the timing of the drive voltage (phase voltage) of the coil of the predetermined phase reaching a high level and the timing of the PWM signal for turning on/off the high-side switch corresponding to the predetermined phase reaching a high level for each cycle of the drive control signal Sd. The drive control signal Sd is a PWM signal. The estimation method for the zero-crossing point Q of the coil current performed by the current zero-crossing point estimation unit 14 is elaborated below with reference to the drawings.

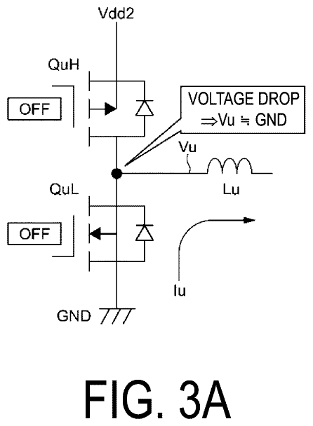

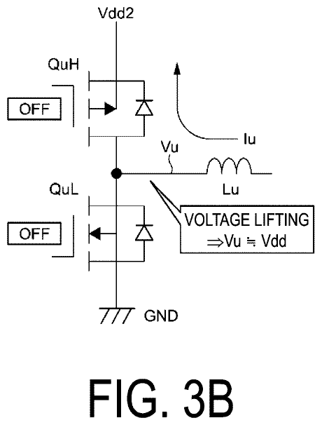

FIG. 3A is a diagram for describing a state of a U-phase high-side switch QuH and a U-phase low-side switch QuL being turned off in a state of a U-phase coil current Iu with positive (+) polarity flowing through a U-phase coil Lu.

FIG. 3B is a diagram for describing a state of a U-phase high-side switch QuH and a U-phase low-side switch QuL being turned off in a state of a U-phase coil current Iu with negative (−) polarity flowing through the U-phase coil Lu.

For example, when the PWM signal Suu is at a high level, and the PWM signal Sul is at a low level at the U-phase high-side switch QuH and the U-phase low-side switch QuL, the U-phase high-side switch QuH is turned on, and the U-phase low-side switch QuL is turned off. At this time, the current flows into the U-phase coil Lu from the power source voltage Vdd2 via the U-phase high-side switch QuH, and thus the U-phase coil current Iu has positive (+) polarity.

In this state, i.e., in the state of the U-phase coil current Iu with positive (+) polarity flowing through the U-phase coil Lu, when both the U-phase high-side switch QuH and the U-phase low-side switch QuL are turned off, the coil Lu acts to keep the current flowing. Therefore, as illustrated in FIG. 3A, the positive U-phase coil current Iu flows from the ground potential GND via the parasitic diode of the low-side switch QuL. As a result, the drive voltage Vu of the U-phase coil Lu drops to near the ground potential GND.

Thereafter, to set the state of the U-phase high-side switch QuH being turned on and the U-phase low-side switch QuL being turned off again, the state is controlled to the state of the PWM signal Suu being at a high level and the PWM signal Sul being at a low level. At this time, the drive voltage Vu of the U-phase coil Lu has dropped to near the ground potential GND, and therefore increases after the PWM signal Suu for turning on/off the high-side switch QuH changes to a high level.

As a result, in the period of the U-phase coil current Iu having positive (+) polarity, the timing (first timing) of the drive voltage Vu of the U-phase coil Lu reaching a high level is after the timing (second timing) of the PWM signal Suu for switching the on/off of the U-phase high-side switch QuH reaching a high level in one cycle of the PWM signal Suu.

On the other hand, when the PWM signal Suu is at a low level and the PWM signal Sul is at a high level at the U-phase high-side switch QuH and the U-phase low-side switch QuL, the U-phase high-side switch QuH turns off, and the U-phase low-side switch QuL turns on. At this time, since the current flows into the ground potential GND side from the U-phase coil Lu via the U-phase low-side switch QuL, the U-phase coil current Iu has negative (−) polarity.

In this state, i.e., in a state of the U-phase coil current Iu with negative (−) polarity flowing through the U-phase coil Lu, when both the U-phase high-side switch QuH and the U-phase low-side switch QuL are turned off, the coil Lu acts to keep the current flowing. Therefore, as illustrated in FIG. 3B, the negative U-phase coil current Iu flows to the power source voltage Vdd2 side from the U-phase coil Lu via the parasitic diode of the high-side switch QuH. As a result, the drive voltage Vu of the U-phase coil Lu increases to near the DC voltage Vdd.

Thereafter, to set the state of the U-phase high-side switch QuH being off and the U-phase low-side switch QuL being on again, the state is controlled to the state of the PWM signal Suu being at a low level and the PWM signal Sul being at a high level. At this time, the drive voltage Vu of the U-phase coil Lu has increased to near the DC voltage Vdd, and therefore increases before the PWM signal Suu for turning on/off the high-side switch QuH changes to a high level.

As a result, in the period of the U-phase coil current Iu having negative (−) polarity, the timing (first timing) of the drive voltage Vu of the U-phase coil Lu reaching a high level is after the timing (second timing) of the PWM signal Suu for switching the on/off of the U-phase high-side switch QuH reaching a high level in one cycle of the PWM signal Suu.

Thus, when the first timing is after the second timing, the U-phase coil current Iu can be determined to have positive (+) polarity, and when the first timing is before the second timing, the U-phase coil current Iu can be determined to have negative (−) polarity.

The current zero-crossing point estimation unit 14 of the first embodiment determines the U-phase coil current Iu to have positive (+) polarity when the rising edge of the drive voltage Vu of the U-phase coil Lu is after the rising edge of the U-phase high-side PWM signal Suu, and determines the U-phase coil current Iu to have negative (−) polarity when the rising edge of the drive voltage Vu of the U-phase coil Lu is before the rising edge of the U-phase high-side PWM signal Suu.

In addition, as described above, when the motor is PWM-driven, the first timing is after the second timing in the period of the U-phase coil current Iu having positive polarity, whereas the second timing is after the first timing in the period of the U-phase coil current Iu having negative polarity in one cycle of the PWM signal Suu. Thus, the zero-crossing point Q of the U-phase coil current Iu can be estimated by detecting the interchanging of the order of the first timing and the second timing.

In view of this, the current zero-crossing point estimation unit 14 of the first embodiment determines the polarity of the U-phase coil current Iu as described above, and further estimates the zero-crossing point Q of the U-phase coil current Iu to be present in the off period of the drive voltage Vu of the U-phase coil Lu while the polarity changes.

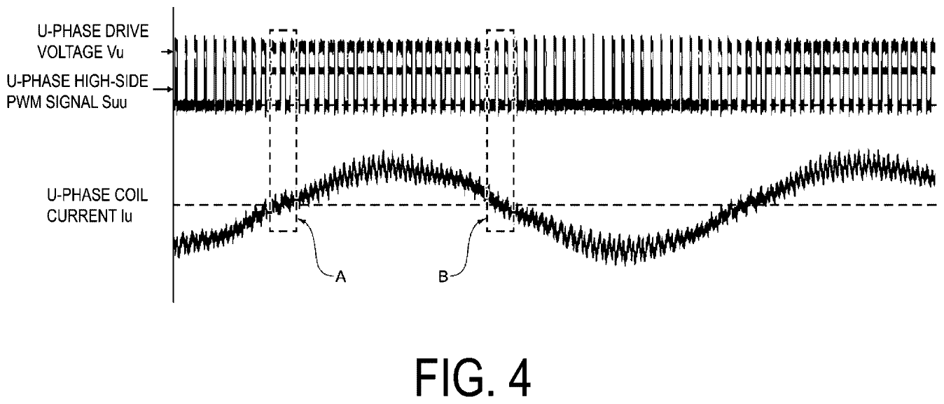

FIG. 4 is a diagram illustrating a state of the U-phase coil Lu being driven.

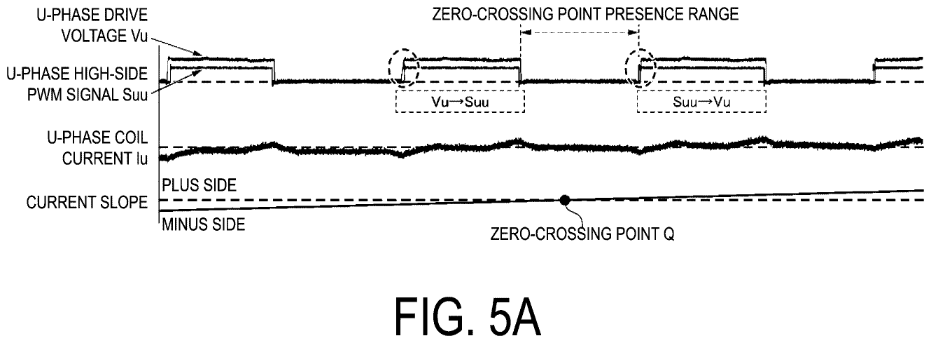

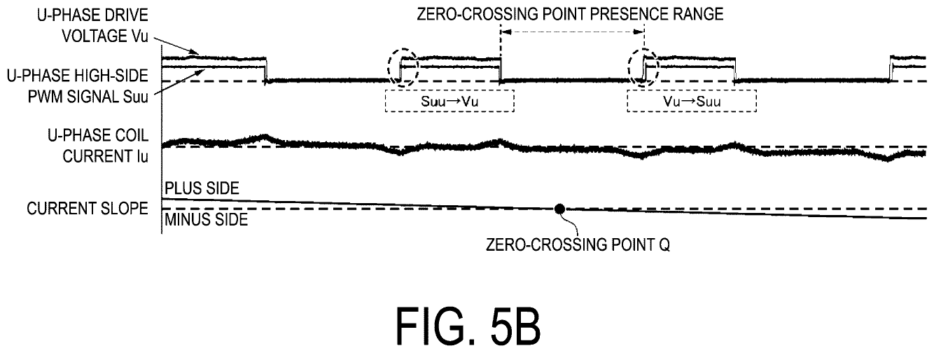

FIG. 5A is an enlarged diagram of the region indicated by the reference symbol A in FIG. 4.

FIG. 5B is an enlarged diagram of the region indicated by the reference symbol B in FIG. 4.

FIG. 5A illustrates a driving state before and after changing from a state of the U-phase coil current Iu with negative (−) polarity flowing through the U-phase coil Lu to a state of the U-phase coil current Iu with positive (+) polarity flowing through the U-phase coil Lu. FIG. 5B illustrates a driving state before and after changing from a state of the U-phase coil current Iu with positive (+) polarity flowing through the U-phase coil Lu to a state of the U-phase coil current Iu with negative (−) polarity flowing through the U-phase coil Lu.

FIG. 4 illustrates waveforms in the order of the drive voltage Vu of the U-phase coil Lu, the PWM signal Suu for driving the U-phase high-side switch QuH, and the U-phase coil current Iu from the upper side toward the lower side. FIG. 5A and FIG. 5B illustrate from the upper side toward the lower side the same waveforms of the FIG. 4 and in addition the current slope. In FIG. 4, FIG. 5A and FIG. 5B, the abscissa indicates the time, and the ordinate indicates the current or voltage.

Here, for the estimation of the presence of the zero-crossing point Q of the U-phase coil current Iu at the current zero-crossing point estimation unit 14 of the first embodiment, when the U-phase coil current Iu is driven as illustrated in FIG. 4 is considered below.

In the example illustrated in FIG. 4, the polarity of the U-phase coil current Iu changes to alternate between the negative (−) polarity and the positive (+) polarity.

In the region indicated by the reference symbol A in FIG. 4, the polarity of the U-phase coil current Iu changes from the negative (−) polarity to the positive (+) polarity. As illustrated in FIG. 5A as an enlarged view of this region, before the zero-crossing point presence range, the drive voltage Vu of the U-phase coil Lu changes to a high level before the U-phase high-side PWM signal Suu. Specifically, in the state of the polarity of the U-phase coil current Iu having negative (−) polarity, the rising edge of the drive voltage Vu of the U-phase coil Lu is before the rising edge of the U-phase high-side PWM signal Suu.

On the other hand, as illustrated in FIG. 5A, after the zero-crossing point presence range, the drive voltage Vu of the U-phase coil Lu changes to a high level after the U-phase high-side PWM signal Suu. Specifically, in the state of the U-phase coil current Iu having positive (+) polarity, the rising edge of the drive voltage Vu of the U-phase coil Lu is after the rising edge of the U-phase high-side PWM signal Suu.

As such, considerably, in the region indicated by the reference symbol A in FIG. 4 and in FIG. 5A, the result of the determination on the polarity of the U-phase coil current Iu changes from the negative (−) polarity to the positive (+) polarity between before and after the zero-crossing point presence range.

In the region indicated by the reference symbol B in FIG. 4, the U-phase coil current Iu changes from the positive (+) polarity to the negative (−) polarity. As illustrated in FIG. 5B as an enlarged view of this region, before the zero-crossing point presence range, the drive voltage Vu of the U-phase coil Lu changes to a high level after the U-phase high-side PWM signal Suu. Specifically, in the state of the U-phase coil current Iu having positive (+) polarity, the rising edge of the drive voltage Vu of the U-phase coil Lu is after the rising edge of the U-phase high-side PWM signal Suu.

On the other hand, as illustrated in FIG. 5B, after the zero-crossing point presence range, the drive voltage Vu of the U-phase coil Lu changes to a high level before the U-phase high-side PWM signal Suu. Specifically, in the state of the polarity of the U-phase coil current Iu having negative (−) polarity, the rising edge of the drive voltage Vu of the U-phase coil Lu is before the rising edge of the U-phase high-side PWM signal Suu.

As such, in the region indicated by the reference symbol B in FIG. 4 and in FIG. 5B, the result of the determination on the polarity of the U-phase coil current Iu changes from the positive (+) polarity to the negative (−) polarity between before and after the zero-crossing point presence range.

As can be seen in FIG. 5A and FIG. 5B, the zero-crossing point Q of the U-phase coil current Iu is present in the off period of the drive voltage Vu of the U-phase coil Lu while the polarity of the U-phase coil current Iu changes.

As such, it suffices for the current zero-crossing point estimation unit 14 of the first embodiment to determine the polarity of the U-phase coil current Iu as having changed when an interchange occurs in the order of the timing of the drive voltage Vu of the U-phase coil Lu reaching a high level and the timing of the U-phase high-side PWM signal Suu reaching a high level, and determines the zero-crossing point presence range to be present in the off period of the drive voltage Vu of the U-phase coil Lu during the change of the polarity of the U-phase coil current Iu.

The current zero-crossing point estimation unit 14 of the first embodiment is further described below.

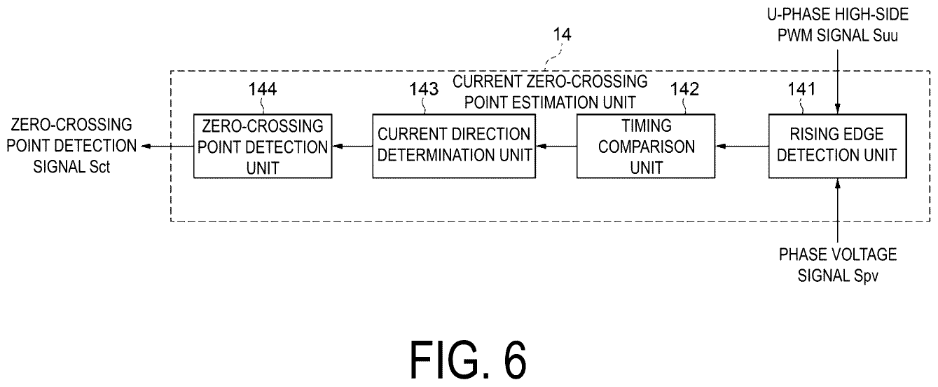

FIG. 6 is a diagram illustrating a configuration example of the current zero-crossing point estimation unit 14 in the first embodiment.

As illustrated in FIG. 6, in the motor drive control device 1 of the first embodiment, the current zero-crossing point estimation unit 14 includes an edge detection unit 141, a timing comparison unit 142, a current direction determination unit 143, and a zero-crossing point detection unit 144. The current zero-crossing point estimation unit 14 can be made up of a microcomputer and/or a logic circuit.

As illustrated in FIG. 6, the phase voltage signal Spv and the U-phase high-side PWM signal Suu acquired by the phase voltage input unit 13 are input to the rising edge detection unit 141. The phase voltage signal Spv corresponds to the above-described drive voltage Vu of the U-phase coil Lu. The rising edge detection unit 141 detects the rising edge of the drive voltage Vu of the U-phase coil Lu, and the rising edge of the U-phase high-side PWM signal Suu in the phase voltage signal Spv.

The timing comparison unit 142 determines the order of the rising by comparing the detection timings detected by the rising edge detection unit 141. Specifically, by comparing the detection timings of the rising edge of the U-phase high-side PWM signal Suu and the detection timing of the rising edge of the drive voltage Vu of the U-phase coil Lu detected by the rising edge detection unit 141, the timing comparison unit 142 determines the order of the rising, i.e., the order of the timing of the drive voltage Vu of the U-phase coil Lu reaching a high level and the timing of the U-phase high-side PWM signal Suu reaching a high level.

The current direction determination unit 143 determines the U-phase coil current Iu to have positive polarity when the detection of the rising edge of the drive voltage Vu of the U-phase coil Lu is after the detection of the rising edge of the PWM signal Suu for turning on/off the U-phase high-side switch QuH, and determines the U-phase coil current Iu to have negative polarity when the detection of the rising edge of the drive voltage Vu of the U-phase coil Lu is before the detection of the rising edge of the U-phase high-side switch QuH. Further, the current direction determination unit 143 determines the U-phase coil current Iu to have negative polarity when the duty ratio of the PWM signal Suu for driving the U-phase high-side switch QuH is 0%.

The zero-crossing point detection unit 144 estimates the zero-crossing point Q of the U-phase coil current Iu to be present in the off period of the drive voltage Vu of the U-phase coil Lu while the U-phase coil current Iu changes from the positive polarity to the negative polarity, or from the negative polarity to the positive polarity.

In this manner, in the motor drive control device 1 of the first embodiment, the current zero-crossing point estimation unit 14 can detect the presence of the zero-crossing point Q of the U-phase coil current Iu. The zero-crossing point detection unit 144 of the current zero-crossing point estimation unit 14 outputs the phase information of the zero-crossing point Q of the U-phase coil current Iu to the phase adjustment determination unit 15 as a zero-crossing point detection signal Sct when detecting the presence of the zero-crossing point Q of the U-phase coil current Iu.

Referring to FIG. 1 again, the phase adjustment determination unit 15 specifies the phase of the zero-crossing point Q of the U-phase coil current Iu on the basis of the zero-crossing point detection signal Sct, and specifies the phase determined as the target point P of the zero-crossing of the U-phase coil current Iu on the basis of the target point determination signal St. The phase adjustment determination unit 15 determines the necessity of the phase adjustment of the U-phase coil current Iu on the basis of a phase difference Δφ between the target point P of the zero-crossing of the U-phase coil current Iu determined by the target point determination unit 12 and the zero-crossing point Q of the U-phase coil current Iu estimated by the current zero-crossing point estimation unit 14.

For example, as illustrated in FIG. 2, the phase adjustment determination unit 15 calculates the phase difference Δφ (=the phase at the time tp−the phase at the time tq) obtained by subtracting the phase (time tq) of the zero-crossing point Q of the U-phase coil current Iu estimated by the current zero-crossing point estimation unit 14 from the phase (time tp) of the target point P of the zero-crossing of the U-phase coil current Iu determined by the target point determination unit 12 (the zero-crossing point of the induced voltage of the U-phase coil Lu).

The phase adjustment determination unit 15 instructs the drive control signal generation unit 16 to shift the output timing of the drive control signal Sd by the time corresponding to the phase difference Δφ (=the phase at the time tp−the phase at the time tq).

More specifically, when the phase difference Δφ has a positive (+) value, e.g., when the phase difference Δφ is equal to or greater than +φth, the phase adjustment determination unit 15 determines the phase of the U-phase coil current Iu as having advanced more than the phase of the induced voltage of the U-phase coil Lu, and instructs the drive control signal generation unit 16 to perform an advance angle control to delay the phase of the U-phase coil current Iu. For example, the phase adjustment determination unit 15 outputs the determination result S2 for instructing the execution of the advance angle control to delay the U-phase coil current Iu by the phase difference Δφ.

When the phase difference Δφ has a negative (−) value, e.g., when phase difference Δφ is equal to or smaller than −φth, the phase adjustment determination unit 15 determines the phase of the U-phase coil current Iu as being delayed more than the phase of the induced voltage of the U-phase coil Lu, and instructs the drive control signal generation unit 16 to execute the advance angle control to advance the phase of the U-phase coil current Iu. For example, the phase adjustment determination unit 15 outputs the determination result S2 for instructing the execution of the advance angle control to advance the U-phase coil current Iu by the phase difference Δφ.

In addition, for example, when the phase difference Δφ is greater than −φth and smaller than +φth (−φth<Δφ<+φth), the phase adjustment determination unit 15 determines the phase of the U-phase coil current Iu as substantially coinciding with the phase of the induced voltage of the U-phase coil Lu, and outputs the determination result S2 for instructing to perform neither the advance angle control nor the delay angle control.

On the basis of the determination result S2 of the phase adjustment determination unit 15, the drive control signal generation unit 16 generates the drive control signal Sd so as to reduce the difference between the zero-crossing point Q of the U-phase coil current Iu and the target point P of the zero-crossing of the U-phase coil current Iu. More specifically, on the basis of the determination result S2 of the phase adjustment determination unit 15, the PWM command unit 17 generates the value for designating the output timing of the PWM signals Suu, Sul, Svu, Svl, Swu and Swl, and outputs this value as the operation amount S3 together with the value of the on period of the PWM signal and the PWM cycle.

Here, the value for designating the output timing of the PWM signals Suu, Sul, Svu, Svl, Swu and Swl is a value for designating a temporal shift width (offset time) with respect to the reference time for outputting the PWM signals Suu, Sul, Svu, Svl, Swu and Swl serving as the drive control signal Sd.

For example, when the determination result S2 for instructing execution of the advance angle control to advance the angle by the phase difference Δφ is output from the phase adjustment determination unit 15, the PWM command unit 17 calculates the value “−Δtφ” for instructing the output of the PWM signals Suu, Sul, Svu, Svl, Swu and Swl at a timing earlier than the reference time by the time Δtφ corresponding to the phase difference Δφ, and sets this value to the value for designating the output timing of the PWM signals Suu, Sul, Svu, Svl, Swu and Swl.

In addition, for example, when the determination result S2 for instructing the execution of the advance angle control to delay by the phase difference Δφ is output from the phase adjustment determination unit 15, the PWM command unit 17 calculates the value “+Δtφ” for instructing the output of the PWM signals Suu, Sul, Svu, Svl, Swu and Swl at a timing later than the reference time by the time Δtφ corresponding to the phase difference Δφ, and sets this value to the value for designating the output timing of the PWM signals Suu, Sul, Svu, Svl, Swu and Swl.

In addition, for example, when the determination result S2 for instructing execution of neither the advance angle control nor the delay angle control is output as the determination result S2 from the phase adjustment determination unit 15, the PWM command unit 17 sets the value for designating the output timing of the PWM signals Suu, Sul, Svu, Svl, Swu and Swl to “0 (zero)”.

When outputting the drive control signal Sd, the PWM signal generation unit 18 changes the output timing of the drive control signal Sd on the basis of the value for designating the output timing of the PWM signals Suu, Sul, Svu, Svl, Swu and Swl included in the operation amount S3. For example, the reference time for outputting the drive control signal Sd is set in advance, and the PWM signal generation unit 18 outputs the drive control signal Sd at a timing shifted from the reference time by the time designated by the value for designating the output timing of the PWM signals Suu, Sul, Svu, Svl, Swu and Swl.

For example, when the value for designating the output timing of the PWM signals Suu, Sul, Svu, Svl, Swu and Swl is “+Δtφ”, the PWM signal generation unit 18 outputs the drive control signal Sd generated based on the on period information and the PWM cycle included in the operation amount S3 at a timing delayed from the reference time by Δtφ.

For example, when the value for designating the output timing of the PWM signals Suu, Sul, Svu, Svl, Swu and Swl is “−Δtφ”, the PWM signal generation unit 18 outputs the drive control signal Sd generated based on the on period information and the PWM cycle included in the operation amount S3 at a timing earlier than the reference time by Δtφ.

In addition, for example, when the value for designating the output timing of the PWM signals Suu, Sul, Svu, Svl, Swu and Swl is “0 (zero)”, the PWM signal generation unit 18 outputs the drive control signal Sd generated based on the on period information and the PWM cycle included in the operation amount S3 at the reference time without shifting the output timing. Not shifting the output timing means maintaining of the phase adjustment if the phase adjustment (advance angle, delay angle control) has been performed at the time.

Next, a procedure of the drive control of the motor 5 performed by the motor drive control device 1 according to the first embodiment is described.

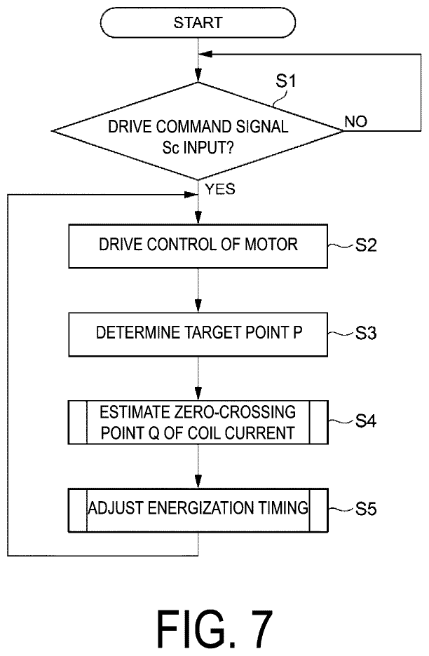

FIG. 7 is a flowchart illustrating a procedure of a motor drive control process of the motor drive control device 1 according to the first embodiment.

For example, when the DC voltage Vdd is input to the motor drive control device 1 and the motor drive control device 1 is activated, the motor drive control device 1 determines first whether the drive command signal Sc has been input (step S1). When the drive command signal Sc has not been input (step S1: NO), the motor drive control device 1 waits for the input of the drive command signal Sc.

When the drive command signal Sc has been input (step S1: YES), the motor drive control device 1 starts the drive control of the motor 5 (step S2). More specifically, the drive control signal generation unit 16 determines the PWM cycle and on period on the basis of the target rotational speed S1 of the motor 5 analyzed by the drive command analysis unit 11, generates six types of PWM signals Suu with the determined PWM cycle and on period and the like, and inputs the signals as the drive control signal Sd to the driving circuit 3. In this manner, the driving circuit 3 rotates the motor 5 by switching the energization direction of the coils Lu, Lv and Lw of the motor 5.

Next, the motor drive control device 1 determines the target point P of the zero-crossing of the U-phase coil current Iu (step S3). For example, as described above, the target point determination unit 12 determines the timing advanced from the rising edge of the position detection signal Shu by an electrical angle of 30 degrees to be the target point P of the zero-crossing of the U-phase coil current Iu (see FIG. 2).

Next, the motor drive control device 1 estimates the zero-crossing point Q of the U-phase coil current Iu (step S4).

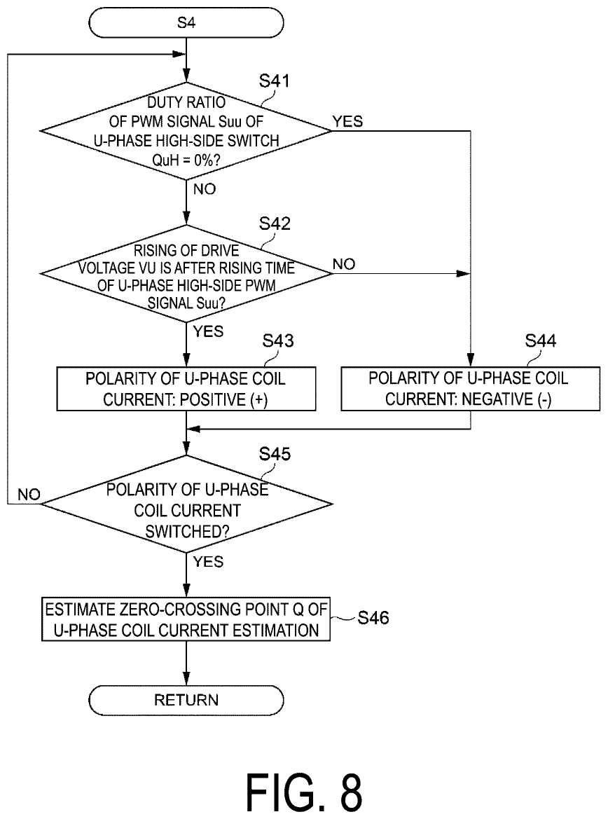

FIG. 8 is a flowchart illustrating a procedure of an estimation process (step S4) of the zero-crossing point Q of the U-phase coil current Iu in FIG. 7.

At step S4, first, the current zero-crossing point estimation unit 14 determines whether the duty ratio of the PWM signal Suu for driving the U-phase high-side switch QuH is 0% (step S41).

When the duty ratio of the PWM signal Suu is 0% (step S41: YES), the current direction determination unit 143 in the current zero-crossing point estimation unit 14 determines the U-phase coil current Iu to have negative polarity (step S44). When the duty ratio of the PWM signal Suu is not 0% (step S41: NO), the current zero-crossing point estimation unit 14 determines whether the rising of the drive voltage Vu of the U-phase coil Lu is after the rising timing of the U-phase high-side PWM signal Suu (step S42). More specifically, in the current zero-crossing point estimation unit 14, the rising edge detection unit 141 detects the rising edge of the U-phase high-side PWM signal Suu and the rising edge of the drive voltage Vu of the U-phase coil Lu, and the timing comparison unit 142 determines the order of the rising by comparing the detection timings.

When the rising of the drive voltage Vu of the U-phase coil Lu is after the rising timing of the U-phase high-side PWM signal Suu (step S42: YES), the current direction determination unit 143 in the current zero-crossing point estimation unit 14 determines the U-phase coil current Iu to have positive polarity (step S43).

On the other hand, when the rising of the drive voltage Vu of the U-phase coil Lu is before the rising timing of the U-phase high-side PWM signal Suu (step S42: NO), the current direction determination unit 143 in the current zero-crossing point estimation unit 14 determines the U-phase coil current Iu to have negative polarity (step S44).

After step S43 or step S44, the zero-crossing point detection unit 144 in the current zero-crossing point estimation unit 14 determines whether the polarity of the U-phase coil current Iu has been switched (step S45). For example, the current zero-crossing point estimation unit 14 determines whether there is a difference between the polarity of the U-phase coil current Iu determined at step S43 or step S44 and the polarity of the U-phase coil current Iu determined at step S43 or step S44 at an earlier timing.

When the polarity of the U-phase coil current Iu has not been switched (step S45: NO), i.e., when the polarity of the U-phase coil current Iu determined at step S43 or step S44, the polarity of the U-phase coil current Iu determined at step S43 or step S44 at an earlier timing coincide with each other, the current zero-crossing point estimation unit 14 returns to step S41, and executes the processes of step S41 to S45 again.

On the other hand, when the polarity of the U-phase coil current Iu has been switched (step S45: YES), i.e., when the polarity of the U-phase coil current Iu determined at step S43 or step S44, the polarity of the U-phase coil current Iu determined at step S43 or step S44 at an earlier timing do not coincide with each other, the current zero-crossing point estimation unit 14 estimates the zero-crossing point Q of the U-phase coil current Iu (step S46). For example, the current zero-crossing point estimation unit 14 estimates one point within the period (the zero-crossing point presence range) between the executed time of step S43 or step S44 and the executed time of step S43 or step S44 at an immediately earlier timing as the zero-crossing point Q of the U-phase coil current Iu (FIG. 5A or see FIG. 5B). Thus, the process of step S4 is completed.

As illustrated in FIG. 7, after the completion of step S4, the motor drive control device 1 adjusts the energization timing of the motor 5 (step S5).

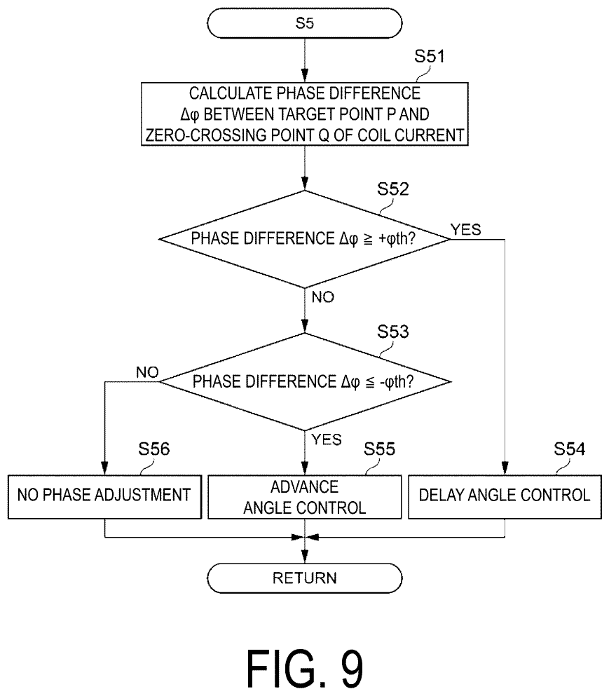

FIG. 9 is a flowchart illustrating a procedure of an adjustment process (step S5) of the energization timing of the motor 5 in FIG. 7.

At step S5, first, the phase adjustment determination unit 15 calculates the phase difference Δφ (=the phase at the time tp−the phase at the time tq) between the target point P of the zero-crossing of the U-phase coil current Iu determined at step S3 and the zero-crossing point Q of the U-phase coil current Iu estimated at step S4 (step S51).

Next, the phase adjustment determination unit 15 determines whether the phase difference Δφ calculated at step S51 is equal to or greater than +φth (step S52). When the phase difference Δφ is equal to or greater than +φth (step S52: YES), the phase adjustment determination unit 15 determines the phase of the U-phase coil current Iu as having advanced more than the phase of the induced voltage of the U-phase coil Lu, and instructs the drive control signal generation unit 16 to execute the delay angle control of delaying the phase of the U-phase coil current Iu (step S54). In this manner, as described above, the drive control signal generation unit 16 outputs the drive control signal Sd at a timing delayed from the reference time by the time Δtφ corresponding to the phase difference Δφ.

On the other hand, at step S52, when the phase difference Δφ is smaller than +φth (step S52: NO), the phase adjustment determination unit 15 determines whether the phase difference Δφ is equal to or smaller than −φth (step S53). When the phase difference Δφ is equal to or smaller than −φth (step S53: YES), the phase adjustment determination unit 15 determines the phase of the U-phase coil current Iu as being delayed more than the phase of the induced voltage of the U-phase coil Lu, and instructs the drive control signal generation unit 16 to execute the advance angle control of advancing the phase of the U-phase coil current Iu (step S55). In this manner, as described above, the drive control signal generation unit 16 outputs the drive control signal Sd at a timing earlier than the reference time by the time Δtφ corresponding to the phase difference Δφ.

On the other hand, at step S53, when the phase difference Δφ is greater than −φth (step S53: NO), the phase adjustment determination unit 15 determines the zero-crossing point Q of the U-phase coil current Iu to be within the target range of the target point P of the zero-crossing of the U-phase coil current Iu, and does not instruct the drive control signal generation unit 16 to execute the phase adjustment of the U-phase coil current Iu (step S56). In this manner, as described above, the drive control signal generation unit 16 outputs the drive control signal Sd at the reference time without shifting the output timing.

Thus, the process of step S5 is completed.

As illustrated in FIG. 7, after the completion of step S5, the motor drive control device 1 returns to step S2, and repeats the processes of step S2 to S5. In this manner, the rotation of the motor 5 continues without reducing the drive efficiency.

As described above, the motor drive control device 1 according to the first embodiment determines the target point P of the zero-crossing of the coil current of the predetermined phase on the basis of the position detection signal Shu synchronized with the induced voltage of the coil of the predetermined phase of the motor 5, compares the detection timings of the detection of the rising edge of the drive voltage of the coil of the predetermined phase and the detection of the rising edge of the switch signal for turning on/off the high-side switch for driving the coil of the predetermined phase, and estimates the zero-crossing point Q of the coil current of the predetermined phase on the basis of the comparison result. On the basis of the estimated phase difference Δφ of the zero-crossing point Q of the coil current of the predetermined phase and the zero-crossing target point P (=the phase at the time tp−the phase at the time tq), the motor drive control device 1 determines the necessity of the phase adjustment of the coil current, and generates the drive control signal Sd (PWM signal) for driving the motor 5 on the basis of the determination result S2.

As described above, with the position detection device 6 (Hall element) disposed at a position corresponding to the coil of the predetermined phase of the motor 5, the position detection signal Shu synchronized with the induced voltage of the coil of the predetermined phase can be obtained. Then, when the phase difference between the position detection signal Shu and the induced voltage between is known, the zero-crossing point of the induced voltage, i.e., the zero-crossing target point P of the coil current of the predetermined phase of the motor 5 can be determined on the basis of the rising edge or falling edge of the position detection signal Shu.

### Second Embodiment

Next, a motor drive control device 1A according to a second embodiment (not illustrated in the drawing) is described.

The motor drive control device 1A of the second embodiment has the same configuration as the configuration of the motor drive control device 1 of the first embodiment except for the following points: a current zero-crossing point estimation unit 14A is used instead of the current zero-crossing point estimation unit 14, and therefore the description for the same configuration will be omitted.

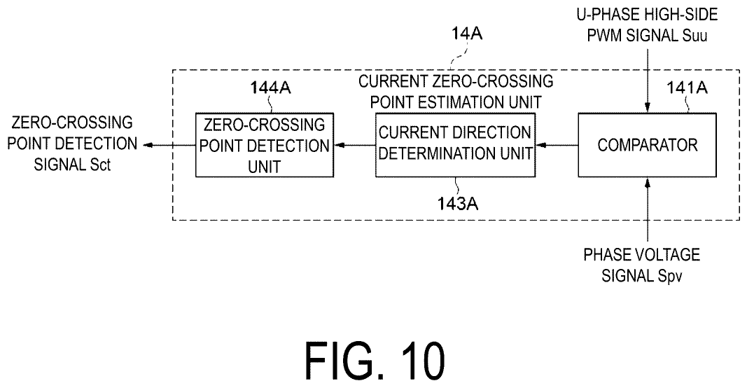

FIG. 10 is a diagram illustrating a configuration example of the current zero-crossing point estimation unit 14A in the second embodiment.

In the first embodiment, the current zero-crossing point estimation unit 14 determines the polarity of the U-phase coil current Iu on the basis of the order of the detection timing of the rising edge of the drive voltage Vu of the U-phase coil Lu and the rising edge of the U-phase high-side PWM signal Suu. In the second embodiment, the method for the current zero-crossing point estimation unit 14A to determine the polarity of the U-phase coil current Iu is different from the first embodiment. The current zero-crossing point estimation unit 14A is configured to compare the magnitude of the drive voltage Vu of the U-phase coil Lu and the magnitude of the voltage of U-phase high-side PWM signal (an example of the switch signal) Suu and output a comparison result signal when the magnitude of the voltage of the U-phase high-side PWM signal Suu is greater than the magnitude of the drive voltage Vu of the U-phase coil Lu. Further, the current zero-crossing point estimation unit 14A determines the U-phase coil current Iu to have positive (+) polarity when the rising edge of the comparison result signal is detected in a certain period of time.

FIG. 10 is a diagram illustrating a configuration example of the current zero-crossing point estimation unit 14A in the second embodiment.

In the motor drive control device 1A of the second embodiment, as illustrated in FIG. 10, the current zero-crossing point estimation unit 14A includes a comparator 141A, a current direction determination unit 143A, and a zero-crossing point detection unit 144A. The current zero-crossing point estimation unit 14A can be made up of a microcomputer and/or a logic circuit.

As illustrated in FIG. 10, the phase voltage signal Spv and the U-phase high-side PWM signal Suu acquired by the phase voltage input unit 13 are input to the comparator 141A. The phase voltage signal Spv corresponds to the drive voltage Vu of the U-phase coil Lu. The comparator 141A compares the voltage of the phase voltage signal Spv and the voltage of the U-phase high-side PWM signal Suu, and outputs a comparison result signal when the voltage of the U-phase high-side PWM signal Suu is greater than the voltage of the phase voltage signal Spv.

The drive voltage Vu of the U-phase coil Lu is a voltage corresponding to the power source voltage Vdd2 input to the driving circuit 3, and is therefore, for example, 12 V, and the U-phase high-side PWM signal Suu is a voltage corresponding to the power source voltage Vdd1 input to the control circuit 2, and is therefore, for example 5 V. In this manner, normally, the drive voltage Vu of the U-phase coil Lu is set to a voltage greater than the U-phase high-side PWM signal Suu. Accordingly, the comparator 141A is configured to output a comparison result signal reaching a high level when the U-phase high-side PWM signal Suu is greater than the drive voltage Vu of the U-phase coil Lu. With this configuration, the comparator 141A can output a comparison result signal being a pulsed signal only when the U-phase high-side PWM signal Suu reaches a high level at an earlier timing than the drive voltage Vu of the U-phase coil Lu.

The current direction determination unit 143A determines the U-phase coil current Iu to the positive polarity when the rising edge of the comparison result signal is detected in a certain period of time in the comparator 141A, and determines the U-phase coil current Iu to have negative polarity when the rising edge of the comparison result signal is detected in a certain period of time in the comparator 141A. Further, the current direction determination unit 143A determines the U-phase coil current Iu to have negative polarity when the duty ratio of the PWM signal Suu for driving the U-phase high-side switch QuH is 0%.

Now, determination of the polarity of the U-phase coil current Iu at the current direction determination unit 143A is described.

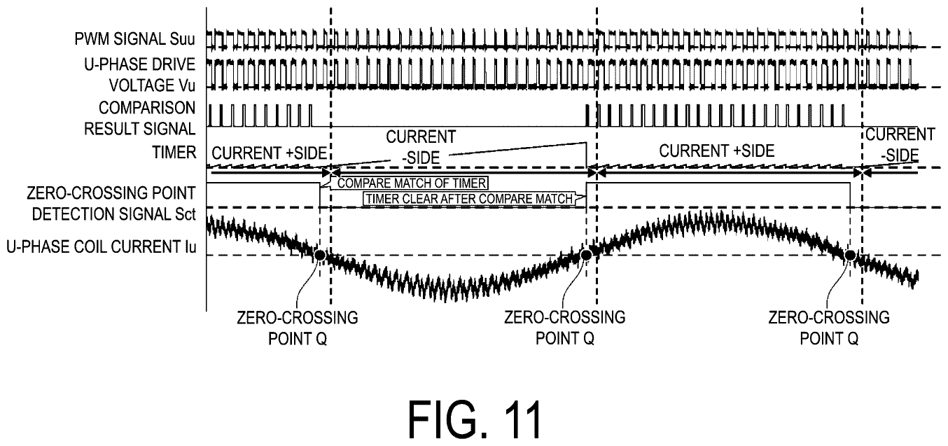

FIG. 11 is a diagram for describing a polarity determination of the current zero-crossing point estimation unit 14A of the second embodiment.

FIG. 11 illustrates waveforms in the order of the PWM signal Suu for driving the U-phase high-side switch QuH, the drive voltage Vu of the U-phase coil Lu, the comparison result signal of the comparator 141A, the count of the timer, the zero-crossing point detection signal Sct, and the U-phase coil current Iu from the upper side toward the lower side. In FIG. 11, the abscissa indicates the time, and the ordinate indicates the current, voltage, or count value.

The current direction determination unit 143A has a timer function of counting up the count value for each cycle of the PWM signal Suu and resetting the count value when the comparison result signal is output from the comparator 141A. The current direction determination unit 143A confirms whether the count value is greater than the predetermined threshold value for each cycle of the PWM signal Suu. The current direction determination unit 143A determines the rising edge of the comparison result signal as being detected in a certain period of time when the count value is not greater than the predetermined threshold value, and determines the rising edge of the comparison result signal as not having been detected in a certain period of time when the count value is greater than the predetermined threshold value.

The current direction determination unit 143A determines the U-phase coil current Iu to have positive (+) polarity when determining the rising edge of the comparison result signal as being detected in a certain period of time, and determines the U-phase coil current Iu to have negative (−) polarity when determining the rising edge of the comparison result signal as not having been detected in a certain period of time.

As illustrated in FIG. 11, the polarity of the U-phase coil current Iu corresponds to the count value of the timer function, and therefore the polarity of the U-phase coil current Iu can be determined by confirming the count value for each cycle of the PWM signal Suu.

As with the zero-crossing point detection unit 144 of the first embodiment, the zero-crossing point detection unit 144A estimates the zero-crossing point Q of the U-phase coil current Iu to be present in the off period of the drive voltage Vu of the U-phase coil Lu while the U-phase coil current Iu changes from the positive polarity to the negative polarity, or from the negative polarity to the positive polarity. For example, when the polarity of the U-phase coil current Iu is changed, the zero-crossing point detection unit 144A determines the output state of the comparison result signal as having changed, and estimates the zero-crossing point Q of the U-phase coil current Iu to be present in the off period of the drive voltage Vu of the U-phase coil Lu during the change.

In this manner, in the motor drive control device 1A of the second embodiment, the current zero-crossing point estimation unit 14A can detect the presence of the zero-crossing point Q of the U-phase coil current Iu. The zero-crossing point detection unit 144A of the current zero-crossing point estimation unit 14A outputs the phase information of the zero-crossing point Q of the U-phase coil current Iu to the phase adjustment determination unit 15 as the zero-crossing point detection signal Sct when detecting the presence of the zero-crossing point Q of the U-phase coil current Iu. The zero-crossing point detection signal Sct is, for example, a pulse signal for indicating the rising edge and the falling edge to be the zero-crossing point Q of the U-phase coil current Iu as illustrated in FIG. 11.

Next, a procedure of the drive control of the motor 5 with the motor drive control device 1A according to the second embodiment is described.

As with the motor drive control device 1 of the first embodiment, the motor drive control device 1A according to the second embodiment executes the processes of step S1 step S3 through the procedure of the motor drive control process illustrated in FIG. 7.

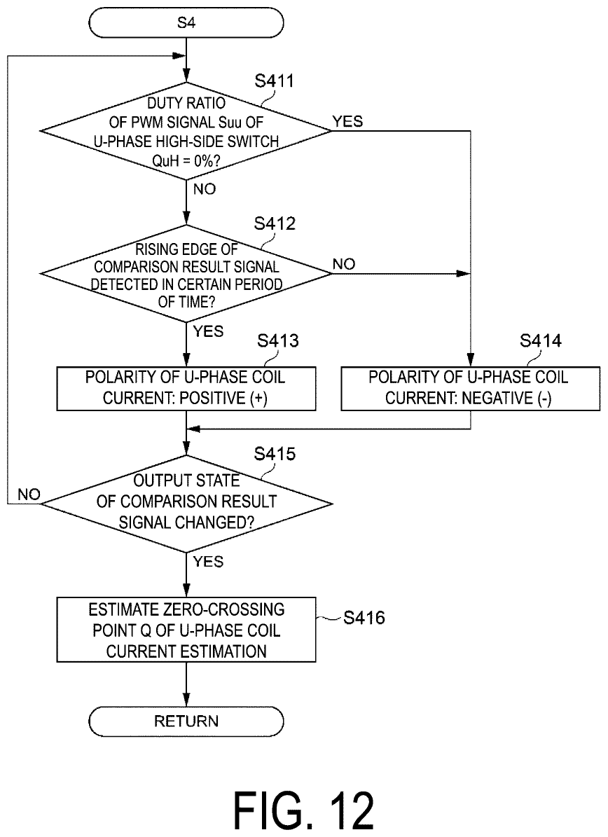

In the motor drive control device 1 of the first embodiment, the estimation process (step S4) of the zero-crossing point Q of the U-phase coil current Iu in FIG. 7 is executed through the procedure of the process (step S4) illustrated in FIG. 8. In the motor drive control device 1A of the second embodiment, the process of step S4 in FIG. 7 is executed through the procedure of the process (step S4) illustrated in FIG. 12 instead of the procedure of the process (step S4) illustrated in FIG. 8. The process of step S4 in the motor drive control device 1A of the second embodiment is described below.

FIG. 12 is a flowchart illustrating a procedure of an estimation process (step S4) of the zero-crossing point Q of the U-phase coil current Iu in the second embodiment.

At step S4, first, the current zero-crossing point estimation unit 14A determines whether the duty ratio of the PWM signal Suu for driving the U-phase high-side switch QuH is 0% (step S411).

When the duty ratio of the PWM signal Suu is 0% (step S411: YES), the current direction determination unit 143A in the current zero-crossing point estimation unit 14A determines the U-phase coil current Iu to have negative polarity (step S414). When the duty ratio of the PWM signal Suu is not 0% (step S411: NO), the current zero-crossing point estimation unit 14A determines whether the rising edge of the comparison result signal has been detected in a certain period of time (step S412). More specifically, in the current zero-crossing point estimation unit 14A, the comparator 141A compares the phase voltage signal Spv corresponding to the drive voltage Vu of the U-phase coil Lu and the U-phase high-side PWM signal Suu, and outputs the comparison result signal when the U-phase high-side PWM signal Suu is larger, and therefore the current direction determination unit 143A determines whether the rising edge of the comparison result signal has been detected in a certain period of time.

When the rising edge of the comparison result signal has been detected in a certain period of time (step S412: YES), the current direction determination unit 143A in the current zero-crossing point estimation unit 14A determines the U-phase coil current Iu to have positive polarity (step S413).

On the other hand, when the rising edge of the comparison result signal has not been detected in a certain period of time (step S412: NO), the current direction determination unit 143A in the current zero-crossing point estimation unit 14A determines the U-phase coil current Iu to have negative polarity (step S414).

After step S413 or step S414, the zero-crossing point detection unit 144A in the current zero-crossing point estimation unit 14A determines whether the output state of the comparison result signal has changed (step S415). For example, when the polarity of the U-phase coil current Iu determined at step S413 or step S414 and the polarity of the U-phase coil current Iu determined at step S413 or step S414 at an earlier timing are different from each other, the zero-crossing point detection unit 144A in the current zero-crossing point estimation unit 14A determines the output state of the comparison result signal as having changed.

When the output state of the comparison result signal has not changed (step S415: NO), i.e., when the polarity of the U-phase coil current Iu determined at step S413 or step S414 and the polarity of the U-phase coil current Iu determined at step S413 or step S414 at an earlier timing coincide with each other, the current zero-crossing point estimation unit 14A returns to step S411, and performs the processes step S411 to S415 again.

On the other hand, when the output state of the comparison result signal has changed (step S415: YES), i.e., when the polarity of the U-phase coil current Iu determined at step S413 or step S414 and the polarity of the U-phase coil current Iu determined at step S413 or step S414 at an earlier timing do not coincide with each other, the current zero-crossing point estimation unit 14A estimates the zero-crossing point Q of the U-phase coil current Iu (step S416). For example, the current zero-crossing point estimation unit 14A estimates one point within the period (the zero-crossing point presence range) between the executed time of step S413 or step S414 and the executed time of step S413 or step S414 at an immediately earlier timing as the zero-crossing point Q of the U-phase coil current Iu. Thus, the process of step S4 is completed.

As illustrated in FIG. 7, after the completion of step S4, step S5 illustrated in FIG. 9 is executed as with the motor drive control device 1 of the first embodiment, and thereafter the motor drive control device 1A returns to step S2, and repeats the processes of step S2 to S5. In this manner, the rotation of the motor 5 continues without reducing the drive efficiency.

As described above, the motor drive control device 1A according to the second embodiment determines the target point P of the zero-crossing of the coil current of the predetermined phase on the basis of the position detection signal Shu synchronized with the induced voltage of the coil of the predetermined phase of the motor 5, compares the magnitude of the drive voltage of the coil of the predetermined phase and the magnitude of the switch signal for turning on/off the high-side switch for driving the coil of the predetermined phase, and estimates the zero-crossing point Q of the coil current of the predetermined phase on the basis of the comparison result. As with the motor drive control device 1 of the first embodiment, on the basis of the estimated phase difference Δφ of the zero-crossing point Q of the coil current of the predetermined phase and the zero-crossing target point P, the motor drive control device 1A determines the necessity of the phase adjustment of the coil current, and generates the drive control signal Sd (PWM signal) for driving the motor 5 on the basis of the determination result S2.

As described above, the motor drive control devices 1 and 1A according to the first and second embodiments determine the target point P of the zero-crossing of the coil current of the predetermined phase on the basis of the position detection signal Shu synchronized with the induced voltage of the coil of the predetermined phase of the motor 5, and estimate the zero-crossing point Q of the coil current of the predetermined phase on the basis of interchanging of the order of the timing (first timing) of the drive voltage of the coil of the predetermined phase reaching a high level, and the timing (second timing) of the switch signal for turning on/off the high-side switch for driving the coil of the predetermined phase reaching a high level. On the basis of the estimated phase difference Δφ of the zero-crossing point Q of the coil current of the predetermined phase and the zero-crossing target point P, the motor drive control devices 1 and 1A determine the necessity of the phase adjustment of the coil current, and generates the drive control signal Sd (PWM signal) for driving the motor 5 on the basis of the determination result S2.

As described above, with the position detection device 6 (Hall element) disposed at a position corresponding to the coil of the predetermined phase of the motor 5, the position detection signal Shu synchronized with the induced voltage of the coil of the predetermined phase can be obtained. Then, when the phase difference between the position detection signal Shu and the induced voltage between is known, the zero-crossing point of the induced voltage, i.e., the zero-crossing target point P of the coil current of the predetermined phase of the motor 5 can be determined on the basis of the rising edge or falling edge of the position detection signal Shu.

Further, as described above, in a period of the coil current of a predetermined phase (for example, U-phase) of the motor 5 having positive (+) polarity, the timing of the drive voltage Vu of the U-phase coil Lu reaching a high level is after the timing of the PWM signal Suu for switching the on/off of the U-phase high-side switch QuH reaching a high level, whereas in the period of the coil current having negative (−) polarity, the timing of the drive voltage Vu of the U-phase coil Lu reaching a high level is before the timing of the PWM signal Suu for switching the on/off of the U-phase high-side switch QuH reaching a high level. As such, by comparing the timing of the drive voltage Vu of the U-phase coil Lu reaching a high level and the timing of the PWM signal Suu for switching the on/off of the U-phase high-side switch QuH reaching a high level, the zero-crossing point Q of the coil current being switched from the positive polarity to the negative polarity, or the zero-crossing point Q of the coil current being switched from the negative polarity to the positive polarity can be detected.

More specifically, the motor drive control device 1 of the first embodiment detects the rising edge of the drive voltage Vu of the U-phase coil Lu and the rising edge of the PWM signal Suu for switching the on/off of the U-phase high-side switch QuH, determines the polarity of the U-phase coil current Iu by comparing the detected detection timings, and estimates the zero-crossing point Q of the U-phase coil current Iu to be present in the off period of the drive voltage Vu of the U-phase coil Lu while the U-phase coil current Iu changes from the positive polarity to the negative polarity, or from the negative polarity to the positive polarity.

In this manner, the motor 5 can easily estimate the zero-crossing point Q of the coil current without directly monitoring the coil current.

Then, the motor drive control device 1 performs phase adjustment in accordance with the phase difference Δφ between the target point P of the zero-crossing of the coil current of the predetermined phase and the zero-crossing point Q of the coil current of the predetermined phase, and thus can reduce the phase difference between the phase of the induced voltage of the coil of the predetermined phase of the motor 5 and the phase of the coil current.

In addition, the motor drive control device 1A of the second embodiment determines the polarity of the U-phase coil current Iu by comparing the magnitude of the drive voltage Vu of the U-phase coil Lu and the magnitude of the voltage of the PWM signal Suu for switching the on/off of the U-phase high-side switch QuH, and estimates the zero-crossing point Q of the U-phase coil current Iu to be present in the off period of the drive voltage Vu of the U-phase coil Lu while the U-phase coil current Iu changes from the positive polarity to the negative polarity, or from the negative polarity to the positive polarity.

In this manner, the motor 5 can easily estimate the zero-crossing point Q of the coil current without directly monitoring the coil current.

Then, the motor drive control device 1A performs phase adjustment in accordance with the phase difference Δφ between the target point P of the zero-crossing of the coil current of the predetermined phase and the zero-crossing point Q of the coil current of the predetermined phase, and thus can reduce the phase difference between the phase of the induced voltage of the coil of the predetermined phase of the motor 5 and the phase of the coil current.

As described above, with the motor drive control devices 1 and 1A according to the first and second embodiments, the drive efficiency of the motor 5 can be improved.

In addition, the motor drive control devices 1 and 1A calculate the phase difference Δφ (=the phase at the time tp−the phase at the time tq) between the target point P of the zero-crossing of the coil current of the predetermined phase and the zero-crossing point Q of the coil current, and shift the output timing of the drive control signal Sd by the time Δtφ (=tp−tq) corresponding to the phase difference Δφ.

In this manner, the phase of the coil current (coil drive voltage) is adjusted by the phase difference Δφ between the target point P of the zero-crossing of the coil current of the predetermined phase and the zero-crossing point Q of the coil current, i.e., the shift width between the phase of the induced voltage and the phase of the coil current, and thus the phase of the coil current can be reliably brought closer to the phase of the induced voltage. Specifically, the drive efficiency of the motor 5 can be improved in comparison with the known technology of detecting the zero-crossing point of the coil current by providing the period (detection period) of the driving of the coil being stopped as in PTL 1.

### Variation of Embodiments

Although the invention made by the inventors has been specifically described based on the embodiments, the invention is not limited to the description and, naturally, can be changed in various ways without departing from the gist.

For example, while the above-mentioned embodiment describes the position detection device 6 disposed for the coil of the U-phase among the three phases (U-phase, V-phase, and W phase) of the motor 5, and the zero-crossing point Q of the U-phase coil current Iu and the drive voltage Vu of the U-phase coil Lu is detected, the present invention is not limited to this configuration. The position detection device 6 may be disposed for the V-phase coil Lv so as to detect the zero-crossing point Q of the drive voltage Vv of the V-phase coil Lv and the V-phase coil current Iv and adjust the phase of the V-phase coil current Iv. Alternatively, the position detection device 6 may be disposed for the W-phase coil Lw so as to detect the zero-crossing point Q of the drive voltage Vw of the W-phase coil Lw and the W-phase coil current Iw and adjust the phase of W-phase coil current Iw. In addition, the position detection device 6 may be disposed for two of U-phase, V-phase and W-phase or all of the phases so as to detect the zero-crossing point Q of the coil current and the drive voltage of any of the phases, and adjust the phase of the coil current of the detected phase.

In the above-described embodiment, an example is described of the current zero-crossing point estimation units 14 and 14A detecting both the timing of a state of the first timing of the drive voltage Vu of the U-phase coil Lu reaching a high level and the second timing of the PWM signal Suu for switching the on/off of the U-phase high-side switch QuH reaching a high level coinciding with each other being switched to a state of the first timing and the second timing not coinciding with each other (the zero-crossing point Q of the U-phase coil current Iu being switched from positive to negative), and the timing of the state of the first timing and the second timing not coinciding with each other being switched to the state of the first timing and the second timing coinciding with each other (the zero-crossing point Q of the U-phase coil current Iu being switched from negative to positive), it is also possible to detect one of the zero-crossing points Q. For example, the current zero-crossing point estimation units 14 and 14A may detect only the zero-crossing point Q of the U-phase coil current Iu being switched from negative to positive.

In the present embodiment, the type of the motor 5 is not limited to a brushless DC motor. In addition, the motor 5 is not limited to a three-phase motor, and may be a single-phase brushless DC motor, for example.

While a Hall element is used as the position detection device 6 in the above-described embodiment, the present invention is not limited to this configuration. For example, a Hall IC, an encoder, a resolver or the like may be provided as the position detection device 6, and the detection signal of the device may be input to the motor drive control devices 1 and 1A as the position detection signal Shu.

In addition, the flowchart described above is an example and is not limited to this example. For example, other processing may be inserted between each step or processing may be parallelized.

### REFERENCE SIGNS LIST

1, 1A Motor Drive Control Device, 2 Control Circuit, 3 Driving Circuit, 4 Phase Voltage Detection Circuit, 5 Motor, 6 Position Detection Device, 11 Drive Command Analysis Part, 12 Target Point Determination Part, 13 Phase Voltage Input Part, 14, 14A Current Zero-Crossing Point Estimation Part, 15 Phase Adjustment Determination Part, 16 Drive Control Signal Generation Part, 17 PWM Command Part, 18 PWM Signal Generation Part, 100 Motor Unit, 200 Waveform of Position Detection Signal Shu, 201 Waveform of Drive Voltage Vu of U-Phase Coil Lu, 202 Waveform of Induced Voltage of U-Phase Coil Lu, 203 Waveform of U-Phase Coil Current Iu, 141 Rising Edge Detection Part, 141A Comparator, 142 Timing Comparison Part, 143, 143A Current Direction Determination Part, 144, 144A Zero-Crossing Point Detection Part, Lu, Lv and Lw Coil, Iu U-Phase Coil Current, S1 Target Rotational Speed, S2 Determination Result, S3 Operation Amount, Sc Drive Command Signal, Sct Zero-Crossing Point Detection Signal, Shu Position Detection Signal, St Target Point Determination Signal, Sd Drive Control Signal, Suu, Sul, Svu, Svl, Swu, Swl PWM Signal (Example of Switch Signal), Quh, Qvh, Qwh High-Side Switch, Qul, Qvl, Qwl Low-Side Switch, Δφ, +ΦTh, −ΦTh Phase Difference, Vu Drive Voltage of Coil Lu, Vv Drive Voltage of Coil Lv, Vw Drive Voltage of Coil Lw, Vdd DC Voltage, Vdd1, Vdd2 Power Source Voltage, P Zero-Crossing Target Point of Coil Current, Q Zero-Crossing Point of Coil Current

1. A motor drive control device comprising:
a control circuit configured to generate a drive control signal being a PWM signal for driving a motor including at least a coil of one phase; and
a driving circuit including a high-side switch and a low-side switch provided corresponding to a coil of each phase of the motor and connected in series with each other, the driving circuit being configured to switch an energization direction of a coil of a corresponding phase by alternately turning on/off the high-side switch and the low-side switch in accordance with the drive control signal, wherein
the control circuit configured to:
determining a zero-crossing target point of a coil current of a predetermined phase of the motor, based on a position detection signal synchronized with an induced voltage of a coil of the predetermined phase and corresponding to a rotation position of a rotor of the motor;
estimating, for each cycle of the PWM signal, a zero-crossing point of the coil current of the predetermined phase based on interchanging of an order of a timing of a drive voltage of the coil of the predetermined phase reaching a high level and a timing of a switch signal for turning on/off the high-side switch corresponding to the predetermined phase reaching a high level;
determining necessity of phase adjustment of the coil current, based on a phase difference between the target point determined and the zero-crossing point estimated; and
generating the drive control signal, based on a determination result obtained.

2. The motor drive control device according to claim 1, wherein
the control circuit configured to:
detecting each of a rising edge of the drive voltage and a rising edge of the switch signal; and
determining the order by comparing detection timings of the rising edge of the drive voltage and the rising edge of the switch signal detected.

3. The motor drive control device according to claim 2, wherein
the control circuit configured to: determining the coil current of the predetermined phase to have positive polarity when the detection timing of the rising edge of the drive voltage is after the detection timing of the rising edge of the switch signal, and determining the coil current of the predetermined phase to have negative polarity when the detection timing of the rising edge of the drive voltage is before the detection timing of the rising edge of the switch signal.

4. The motor drive control device according to claim 3, wherein
the control circuit configured to: estimating the zero-crossing point to be present in an off period of the drive voltage while the coil current of the predetermined phase changes from having positive polarity to having negative polarity or from having negative polarity to having positive polarity.

5. The motor drive control device according to claim 1, wherein
the control circuit includes a comparator configured to determine the order by comparing a magnitude of the drive voltage and a magnitude of a voltage of the switch signal.

6. The motor drive control device according to claim 5, wherein
the comparator outputs a pulse when the magnitude of the voltage of the switch signal is greater than the magnitude of the drive voltage, and
the control circuit configured to: determining the coil current of the predetermined phase to have positive polarity when an output of the pulse is detected within a certain period of time, and determine the coil current of the predetermined phase to have negative polarity when an output of the pulse is not detected within a certain period of time.

7. The motor drive control device according to claim 6, wherein
the control circuit configured to: estimating the zero-crossing point to be present in an off period of the drive voltage while the coil current of the predetermined phase changes from having positive polarity to having negative polarity or from having negative polarity to having positive polarity.

8. The motor drive control device according to claim 1, wherein the control circuit configured to: calculating the phase difference between the target point and the zero-crossing point; and shifting an output timing of the drive control signal by a time corresponding to the phase difference.

9. A motor unit comprising:
the motor drive control device according to claim 1; and
the motor.

10. A motor drive control method of a motor drive control device, the motor drive control device comprising:
a control circuit configured to generate a drive control signal being a PWM signal for driving a motor including at least a coil of one phase; and
a driving circuit including a high-side switch and a low-side switch provided corresponding to a coil of each phase of the motor and connected in series with each other, the driving circuit being configured to switch an energization direction of a coil of a corresponding phase by alternately turning on/off the high-side switch and the low-side switch in accordance with the drive control signal, wherein
the method comprises the control circuit:
determining a zero-crossing target point of a coil current of a predetermined phase of the motor, based on a position detection signal synchronized with an induced voltage of a coil of the predetermined phase and corresponding to a rotation position of a rotor of the motor;
estimating for each cycle of the PWM signal, a zero-crossing point of the coil current of the predetermined phase based on interchanging of an order of a timing of a drive voltage of the coil of the predetermined phase reaching a high level and a timing of a switch signal for turning on/off the high-side switch corresponding to the predetermined phase reaching a high level;
determining necessity of phase adjustment of the coil current, based on a phase difference between the target point determined in the first step and the zero-crossing point estimated in the second step; and
generating the drive control signal, based on a determination result obtained.
